(19) United States
(12) Patent Application Publication
(10) Pub. No.: US 2007/0227854 A1
(43) Pub. Date: Oct. 4, 2007

(54) Pump mechanism for a vertical seat lift assembly

(76) Inventors: Sebastien Cabrit, Washago (CA); Farouk Bouzid, Bretigny (FR); Luc Terrenoire, Montrouge (FR)

Correspondence Address: PORTER WRIGHT MORRIS & ARTHUR LLP;Attorneys & Counselors at Law, 41 South High Street, Columbus, OH, 43215-6194, US

(21) Appl. No.: 11/394,324

(22) Filed: Mar. 30, 2006

(51) Int. Cl. B60N 2/16

(52) U.S. Cl. 192/223.2; 192/15

(57) ABSTRACT

A pump mechanism for a vertical seat lift assembly includes a control handle pivotable in each direction from a neutral position, a stationary housing assembly, a rotatable drive member for operating the vehicle lift assembly, a clutch assembly operably connecting the drive member to the housing assembly to selectively permit rotation of the drive member relative to the housing assembly in either direction, and control assembly operably connecting the control handle to the clutch assembly to selectively rotate the drive member. The control assembly is located radially outward of the clutch assembly so that the control assembly does not increase the thickness of the pump mechanism.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to position adjustment assemblies for motor vehicle seats and, more particularly, to pump mechanisms for vertical adjustment assemblies of motor vehicle seats.

### BACKGROUND OF THE INVENTION

Adjustment assemblies for adjusting the position of seats within a motor vehicle are generally well known. Most arrangements provide for the seat to be moved or adjusted in forward and rearward directions within a vehicle. In many circumstances, arrangements also provide for the seat to be adjusted in the vertical direction so that the seat can be lowered and raised. Such arrangement is necessary, for example, to accommodate vehicle drivers that are of varying heights.

Some vertical adjustment assemblies used in motor vehicle seats use a pump mechanism. Typically, the pump mechanism includes an actuating member, such as a lever or handle that can be moved in either direction from a neutral position to move a drive member coupled to the vertical adjustment mechanism of the seat. The actuating member is coupled to the drive member by a free wheel brake or clutch to hold the position of the drive member as the actuating member is returned to the neutral position. Thus, the seat can be raised in a step-wise manner by rocking or pumping the lever in one direction from the neutral position and lowered in a step-wise manner by rocking or pumping the lever in the other direction from the neutral position. See, for example, U.S. Pat. Nos. 5,794,479, 6,032,777, 6,178,838, 6,230,867, 6,273,233, and 6,481,557, the disclosures of which are expressly incorporated herein in their entireties by reference, which disclose such vertical lift assemblies,

While these vertical lift assemblies effectively raise and lower the vehicle seats, they are relatively cumbersome and have a relatively large package size. Thus these assemblies are difficult to use in some seat packaging applications. Additionally, there is a never ending desire in the motor vehicle industry to reduce cost, weight, and size. Accordingly, there is a need in the art for an improved pump mechanism for a vertical seat lift assembly.

### SUMMARY OF THE INVENTION

The present invention provides pump mechanism for a vertical seat lift assembly which overcomes at least some of the above-noted problems of the related art. According to the present invention, a pump mechanism for a vertical seat lift assembly comprises, in combination, a control handle pivotable in each direction from a neutral position, a stationary housing assembly, a rotatable drive member for operating the vehicle lift assembly, a clutch assembly operably connecting the drive member to the housing assembly to selectively permit rotation of the drive member relative to the housing assembly in either direction, and control assembly operably connecting the control handle to the clutch assembly to selectively rotate the drive member. The control assembly is located radially outward of the clutch assembly so that the control assembly does not increase the thickness of the pump mechanism.

According to another aspect of the present invention, a pump mechanism for a vertical seat lift assembly comprises, in combination, a control handle pivotable in each direction from a neutral position, a stationary housing assembly, a rotatable drive member for operating the vehicle lift assembly, a clutch assembly operably connecting the drive member to the housing assembly to selectively permit rotation of the drive member relative to the housing assembly in either direction, and a control assembly operably connecting the control handle to the clutch assembly to selectively rotate the drive member. The clutch assembly includes at least two rolling elements located between a rubbing surface fixed to the housing and first and second angled engagement surfaces fixed to the drive member for rotation therewith so that rotation of the drive member in one direction is prevented by engagement of one of the rolling elements with the first angled engagement surface and rotation of the drive member in the other direction is prevented by engagement of the other rolling element with the second angled engagement surface. The clutch assembly further includes a rotatable position controller having tabs adjacent the rolling elements so that rotation of the position controller in one direction disengages the one of the rolling elements engaged with the first angled engagement surface and rotation of the position controller in the other direction disengages the other rolling element from the second angled engagement surface. The control assembly includes a handle support secured to the control handle and at least control two rolling elements located between an engagement surface of the position controller and first and second angled control engagement surfaces fixed to the handle support for rotation therewith so that rotation of the handle support in one direction rotates the position controller in one direction and rotation of the handle support in the other direction rotates the position controller in the other direction.

According to yet another aspect of the present invention, a pump mechanism for a vertical seat lift assembly comprises, in combination, a control handle pivotable in each direction from a neutral position, a stationary housing assembly, a rotatable drive member for operating the vehicle lift assembly, a clutch assembly operably connecting the drive member to the housing assembly to selectively permit rotation of the drive member relative to the housing assembly in either direction, and control assembly operably connecting the control handle to the clutch assembly to selectively rotate the drive member. The clutch assembly includes at least two rolling elements located between a rubbing surface fixed to the housing and first and second angled engagement surfaces fixed to the drive member for rotation therewith so that rotation of the drive member in one direction is prevented by engagement of one of the rolling elements with the first angled engagement surface and rotation of the drive member in the other direction is prevented by engagement of the other rolling element with the second angled engagement surface. The clutch assembly further includes a rotatable position controller having tabs adjacent the rolling elements so that rotation of the position controller in one direction disengages the one of the rolling elements engaged with the first angled engagement surface and rotation of the position controller in the other direction disengages the other rolling element from the second angled engagement surface. The rubbing surface is located radially inward of the first and second angled engagement surfaces. The control assembly includes a handle support secured to the control handle and at least control two rolling elements located between an engagement surface of the position controller and first and second angled control engagement surfaces fixed to the handle support for rotation therewith so that rotation of the handle support in one direction rotates the position controller in one direction and rotation of the handle support in the other direction rotates the position controller in the other direction. The control assembly is located radially outward of the clutch assembly so that the control assembly does not increase the thickness of the pump mechanism.

From the foregoing disclosure and the following more detailed description of various preferred embodiments it will be apparent to those skilled in the art that the present invention provides a significant advance in the technology and art of adjustable motor vehicle seats. Particularly significant in this regard is the potential the invention affords for providing a high quality, reliable, low cost assembly having a relatively small package size. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a side elevational view of an adjustable motor vehicle seat assembly having a pump mechanism according to the present invention;

FIG. 2 is an enlarged left side elevational view of the pump mechanism of FIG. 1;

FIG. 3 is a front elevational view of the pump mechanism of FIGS. 1 and 2;

FIG. 4 is an enlarged right side elevational view of the pump mechanism of FIGS. 1 to 3, wherein a mounting bracket is removed for clarity;

FIG. 5 is an enlarged cross-sectional view taken along line 5-5 of FIG. 2; and

FIG. 6 is an exploded perspective view of the pump mechanism of FIGS. 1 to 5.

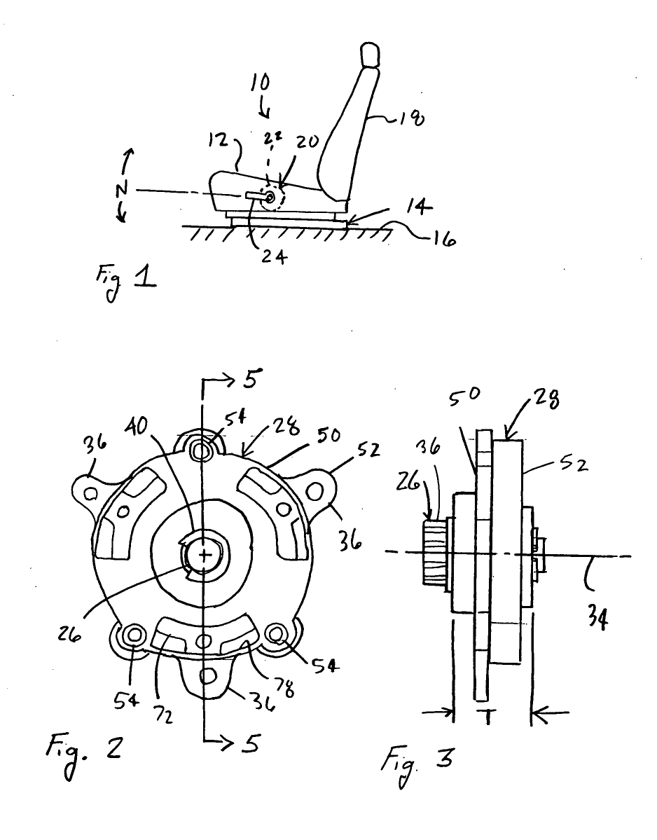

It should be understood that the appended drawings are not necessarily to scale, presenting a somewhat simplified representation of various preferred features illustrative of the basic principles of the invention. The specific design features of an adjustable motor vehicle seat as disclosed herein, including, for example, specific dimensions, orientations, locations, and shapes will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the vehicle seat assembly illustrated in the drawings. In general, up or upward refers to an upward direction within the plane of the paper in FIG. 1 and down or downward refers to a downward direction within the plane of the paper in FIG. 1. Also in general, fore or forward refers to a direction toward the front of the motor vehicle, that is, to the left within the plane of the paper in FIG. 1 and aft or rearward refers to a direction toward the rear of the motor vehicle, that is, to the right within the plane of the paper in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved pump mechanism disclosed herein. The following detailed discussion of various alternative and preferred embodiments will illustrate the general principles of the invention with reference to a vertical lift assembly of a motor vehicle seat. Other embodiments suitable for other applications will be apparent to those skilled in the art given the benefit of this disclosure.

Referring now to the drawings, FIG. 1 schematically shows an adjustable motor vehicle seat assembly 10 according to a preferred embodiment of the present invention. The illustrated vehicle seat assembly 10 includes a seat bottom 12 which is mounted within a vehicle on a mounting assembly 14 to a support structure such as the vehicle floor 16. A seat back 18 is supported with respect to the seat bottom 12. The mounting assembly 14 includes a vertical lift assembly 20 which enables the height of the seat bottom 12 to be raised and lowered. The vertical lift assembly 20 includes an irreversible pump mechanism 22 manually driven by a control lever or handle 24. The illustrated control handle 24 is manually moved by the operator in one direction (preferably the upward direction) from a neutral position N about a lateral horizontally extending axis in a pumping manner to raise the seat bottom 12 and is manually moved by the operator in the other direction (preferably the downward direction) from the neutral position N about the lateral horizontally extending axis in a pumping manner to lower the seat bottom 12.

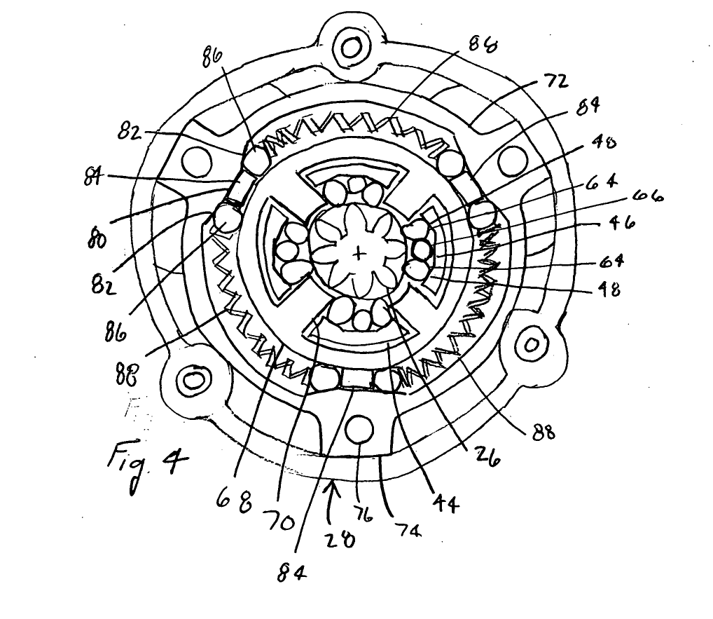

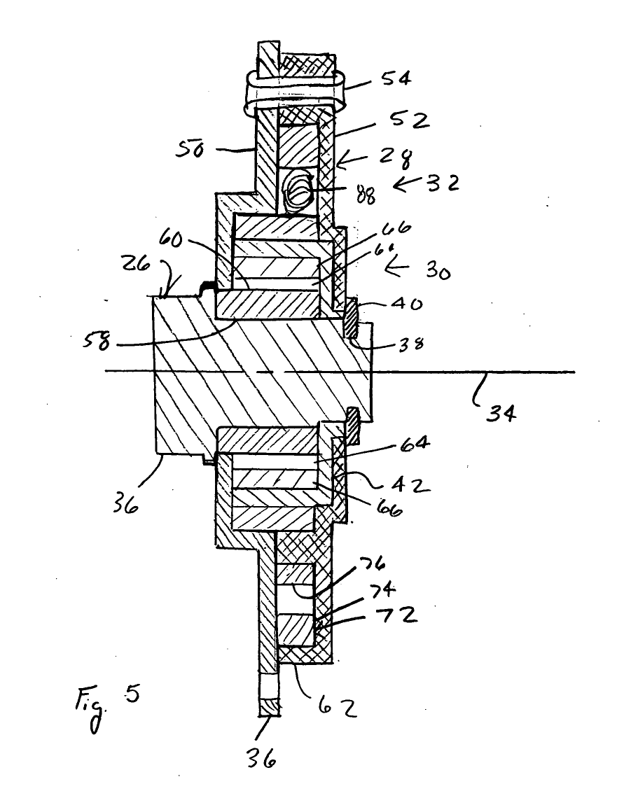

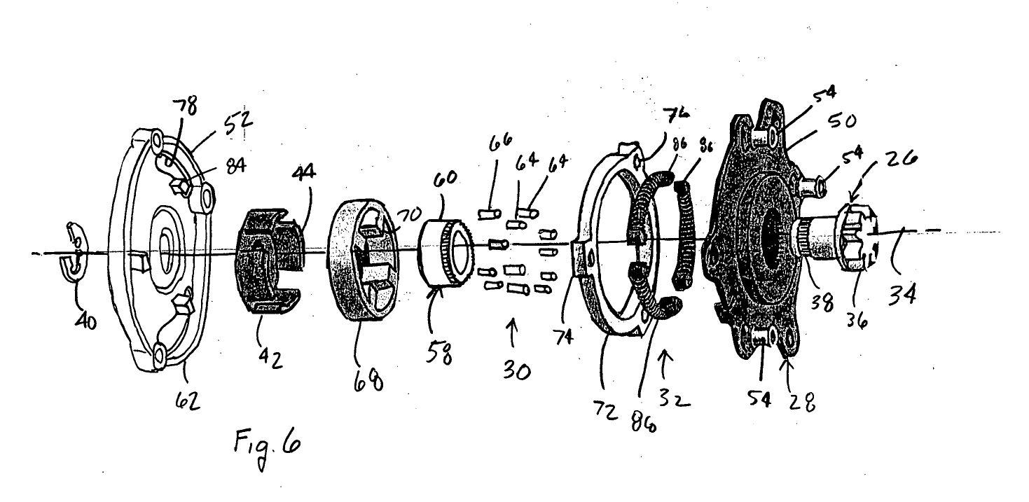

As best shown in FIGS. 2 to 6, the illustrated pumping mechanism 22 includes a rotatable pinion or drive member 26, a stationary housing or mounting bracket assembly 28, a clutch assembly 30 operably connecting the drive member 26 to the housing assembly 28 to selectively irreversibly permit rotation of the drive member 26 relative to the housing assembly 28 in either direction, and a control assembly 32 operably connecting the control handle 24 to the clutch assembly 30 to selectively rotate the drive member 26. It is noted that the first stage or clutch assembly 30 functions to prevent rotation of the drive member 26 in any direction while the second stage or control assembly 32 functions to allow rotation of the drive member 26. These functions are no required to occur simultaneously but sequentially.

The illustrated pinion or drive member 26 forms a central horizontal axis 34 about which it rotates. The illustrated drive member 26 has a pinion or gear 36 formed on an inner end for cooperating with the vertical lift assembly 20 of the seat assembly 10 and a groove 38 near an outer end for cooperating with a retaining or lock ring 40 as described in more detail hereinafter. A flange is provided adjacent the gear 36 that forms an outward facing abutment. The drive member 26 has a cylindrically-shaped shaft portion that extends outwardly from the abutment to the groove 38.

A pinion sleeve 42 is secured to the drive member 26 for rotation therewith. The illustrated drive member 26 and the pinion sleeve 42 are provided with interlocking teeth that cooperate so that the drive member 26 and the pinion sleeve 42 rotate together but they can alternatively be secured for rotation together in any other suitable manner. The illustrated pinion sleeve 42 has a first tubular-shaped portion or wall that is positioned about the shaft portion of the drive member 26, a second annular-shaped portion or wall that radially outwardly extends from an inner end of the first portion, and a plurality of tabs 44 that inwardly extend from an outer periphery of the second portion. The illustrated pinion sleeve 42 includes four equally spaced-apart tabs 44 but any other suitable quantity can alternatively be utilized. The tabs 44 are generally arc shaped about the rotational axis 34. A radially inner side of each tab 44 facing toward the shaft portion of the drive member 26 is provided with a planar central engagement surface 46 that is substantially tangential to the rotational axis 34 and planar outer engagement surfaces 48 inwardly angling from each side of the central engagement surface 46. The engagement surfaces 46, 48 cooperate with the clutch assembly 30 as described in more detail hereinafter.

The illustrated stationary housing or mounting bracket assembly 28 includes an inner housing member 50 and an outer housing member 52 secured together by a plurality of mechanical fasteners 54. The illustrated housing members 50, 52 are secured together by three rivets but any other suitable quantity and/or type of mechanical fasteners can alternatively be utilized. The illustrated inner housing member 50 is generally planer but has a circular-shaped hub formed therein. An outer periphery of the inner housing is provided with a plurality of equally spaced-apart lugs 56 having openings for receiving mechanical fasteners to secure the inner housing member 50 to the seat assembly 10. The illustrated inner housing member 50 has three lugs 56 but any other suitable quantity can alternatively be utilized. The outer periphery of the inner housing member 50 is also provided with openings for receiving the mechanical fasteners 54 securing the inner and outer housing members 50, 52 together. The inner housing member 50 is also provided with a central opening that receives an inner end of a stationary rubbing sleeve 58.

The illustrated stationary rubbing sleeve 58 is generally tubular shaped and sized to closely receive the shaft portion of the drive member 26 therein. The illustrated sleeve 58 is also sized to extend from the abutment of the drive member 26 to second portion of the pinion sleeve 42. The outer side of the rubbing sleeve 58 forms a cylindrically-shaped engagement or rubbing surface 60 that cooperates with the clutch assembly 30 as described in more detail hereinafter. The rubbing sleeve 58 is secured to the inner housing member 50 to prevent rotation so that the rubbing sleeve 58 remains stationary therewith. The illustrated inner housing member 50 and the rubbing sleeve 58 are provided with interlocking teeth that cooperate so that the inner housing member 50 and the rubbing sleeve 58 remain stationary together but they can alternatively be secured for together against relative movement therebetween in any other suitable manner.

The illustrated outer housing member 52 is generally planer but has a circular-shaped hub formed therein and also an inwardly extending flange 62 about its outer periphery that extends to the inner housing member 50. The hub is sized for closely receiving an outer end of the pinion sleeve 42 therein. The outer periphery of the outer housing member 52 is also provided with openings for receiving the mechanical fasteners 54 securing the inner and outer housing members 50, 52 together. The outer housing member 52 is also provided with a central opening that receives an outer end of the first portion of the pinion sleeve 42 therein.

The drive member 26 extends through the central openings of the inner and outer housing members 50, 52 and is supported by the housing assembly 28. The drive member 26 is rotatable about the rotational axis 34 relative to the inner and outer housing members 50, 52 but longitudinal movement of the drive member 26 relative to the inner and outer housing members 50, 52 is limited by the lock or retaining ring 40 removeably secured in the groove 38 of the drive member 26. Mounted in this manner, the abutment of the drive member 26 engages the inner side of the inner housing member 50 and the retaining ring 40 engages the outer side of the outer housing member 52 to substantially prevent longitudinal movement of the drive member 26 relative to the housing assembly 28.

The illustrated clutch assembly 30 includes a pair of rolling elements 64 located between each tab 44 of the pinion sleeve 42 and the rubbing sleeve 58. The illustrated rolling elements 64 are cylindrically-shaped rollers but any other suitable type of rolling element can alternatively be utilized. The rolling elements 64 are positioned so that they engage both the outer engagement surface 60 of the rubbing sleeve 58 and the outer engagement surfaces 48 of the pinion sleeve tabs 44. Spring members 66 are provided to resiliently bias the rolling elements 64 into engagement. The illustrated spring members 66 are cylindrically-shaped rollers formed of a resilient material such as, for example, rubber but the spring members can alternatively be any other suitable type of spring member. The illustrated spring members 66 are positioned between the rolling elements 64 of each pair so that the spring members 66 bias the rolling elements 64 into engagement with the angled outer engagement surfaces 48 and are wedged between the tabs 44 and the pinion sleeve 42. In this static friction condition, one rolling element 64 of each pair prevents rotation of the pinion sleeve 42 and the drive member 26 relative to the housing assembly 28 in one direction and the other rolling element 64 of each pair prevents rotation of the pinion sleeve 42 and the drive member 26 relative to the housing assembly 28 in the other direction.

The illustrated clutch assembly 30 also includes a position controller 68 that selectively moves the rolling elements 64 out of locking engagement so that the drive member 26 can be rotated relative to the housing assembly 28. The illustrated position controller 68 is generally tubular shaped and has a plurality of equally-spaced apart tabs 70 extending radially inward from the inner periphery. The illustrated position controller 68 has three tabs 70 but any other suitable quantity can alternatively be utilized. The illustrated position controller 68 is sized and shaped to be positioned between the inner and outer housing members 50, 52 within the hub of the inner housing member 50 and radially outward of the pinion sleeve 42. The tabs 70 are sized and shaped to extend between the tabs 44 of the pinion sleeve 42 so that rotation of the position controller 68 in one direction disengages one of the rolling elements 64 of the pair so that the pinion sleeve 42 and the drive member 26 can be rotated in that direction and rotation of the position controller 68 in the other direction disengages the other one of the pair of rolling elements 64 so that the pinion sleeve 42 and the drive member 26 can be rotated in that direction.

The illustrated control assembly 32 includes a handle support 72 which operably connects the control handle 24 to the clutch assembly 30. The illustrated handle support is generally tubular shaped having a length sized to fit closely between the inner and outer housing members 50, 52 radially inward of the outer housing member flange 62. The illustrated handle support 72 has a plurality of radially outward extending lugs 74 equally space-apart about the outer periphery of the handle support 72. The lugs 74 are sized and shaped to closely conform to the inner surface of the outer housing member flange 62. The illustrated handle support 72 is provided with three of the lugs 74 but any other suitable quantity of the lugs 74 can alternatively be utilized. The illustrated lugs 74 are provided with openings 76 for attachment of the control handle 24 thereto and rotation thereof. The illustrated outer housing member 52 is provided with elongated openings 78 sized and shaped for the control handle 24 to extend to the lugs 74 and pivoting motion of the control handle 24 relative to the housing assembly 28. An inner side of the illustrated handle support 72 at each lug 74 is provided with a planar central engagement surface 80 that is substantially tangential to the rotational axis 34 and planar outer engagement surfaces 82 outwardly angling from each side of the central engagement surface 80. The central engagement surfaces 80 engage tabs 84 of the outer housing member 52 that laterally extend between the position controller 68 and the handle support 72. The outer engagement surfaces 82 cooperate with pairs of rolling elements 86 as described in more detail hereinafter.

The illustrated pairs of rolling elements 86 are located between the position controller 68 and the handle support 72 and on opposite sides of the tabs 84 of the outer housing member 52. The illustrated rolling elements 86 are cylindrically-shaped rollers but any other suitable type of rolling element can alternatively be utilized. The rolling elements 86 are positioned so that they engage both the outer engagement surface of the position controller 68 and the outer engagement surfaces 82 of the handle support 72. Spring members 88 are provided to resiliently bias the rolling elements 86 into engagement. The illustrated spring members 88 are helically coiled compression springs extending between adjacent rolling elements 86 but the spring members 88 can alternatively be any other suitable type of spring member. The spring members 88 are positioned between the rolling elements 86 so that the spring members 88 bias the rolling elements 86 into engagement with the angled outer engagement surfaces 82 and are wedged between the position controller 68 and the handle support 72. In this static friction condition, one rolling element 86 of each pair prevents rotation of the position controller 68 relative to the housing assembly 28 in one direction and the other rolling element 86 of each pair prevents rotation of the position controller 68 relative to the housing assembly 28 in the other direction.

When an operator desires to adjust the height of the seat assembly 10, the operator grasps the control handle 24 and pivots the control handle 24 from its neutral position N. The pivoting motion of the control handle 24 pivots the handle support 72 secured thereto. Motion of the handle support 72 causes the rolling elements 86 to drive the position controller 68 in the same direction as the spring members 88 are compressed until the position controller 68 reaches its end of travel. The tabs 84 of the outer housing member 54 provide support for the spring members 88 and rolling elements 86. When the control handle 24 returns to its neutral position N, the rolling elements 86 return to their neutral position under the action of the spring members 88. As described above, rotation of the position controller 68 enables rotation of the pinion sleeve 42 and the drive member 26 in the same direction. After movement, the rolling elements 64 return to their neutral position under the action of the spring members 66. Thus, the seat assembly 10 can be raised and lowered in a step-wise or ratcheting manner by pumping or rocking the control handle 24 from its neutral position in one direction or the other.

It is apparent from the foregoing disclosure and detailed description that the pump mechanism 22 provides the second stage radially outward of the first stage so that they are stacked radially one on the other so that a thickness T of the housing assembly containing both the first and second stage is not increased by the second stage and thus generally equal to only one stage of prior art devices. This considerably reduces the size and enables additional seat packaging applications. Each of the stages also utilizes the same principle of roller locking with wedging faces located on the outer rings which provides a smaller size, lighter weight and reduced cost compared to prior art devices.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A pump mechanism for a vertical seat lift assembly comprising, in combination:
a control handle pivotable in each direction from a neutral position;
a stationary housing assembly;
a rotatable drive member for operating the vehicle lift assembly;
a clutch assembly operably connecting the drive member to the housing assembly to selectively permit rotation of the drive member relative to the housing assembly in either direction;
control assembly operably connecting the control handle to the clutch assembly to selectively rotate the drive member; and
wherein the control assembly is located radially outward of the clutch assembly so that the control assembly does not increase the thickness of the pump mechanism.

2. The pump mechanism according to claim 1, wherein the clutch assembly includes at least two rolling elements located between a rubbing surface fixed to the housing and first and second angled engagement surfaces fixed to the drive member for rotation therewith so that rotation of the drive member in one direction is prevented by engagement of one of the rolling elements with the first angled engagement surface and rotation of the drive member in the other direction is prevented by engagement of the other rolling element with the second angled engagement surface.

3. The pump mechanism according to claim 2, wherein the rolling elements comprise rollers.

4. The pump mechanism according to claim 2, wherein the clutch assembly further comprises spring members resiliently biasing the rolling elements into engagement with the first and second angled engagement surfaces.

5. The pump mechanism according to claim 4, wherein the spring members comprise resilient rollers.

6. The pump mechanism according to claim 2, wherein the rubbing surface is located radially inward of the first and second angled engagement surfaces.

7. The pump mechanism according to claim 2, wherein the clutch assembly further includes a rotatable position controller having tabs adjacent the rolling elements so that rotation of the position controller in one direction disengages the one of the rolling elements engaged with the first angled engagement surface and rotation of the position controller in the other direction disengages the other rolling element from the second angled engagement surface.

8. The pump mechanism according to claim 7, wherein the control assembly includes a handle support secured to the control handle and at least control two rolling elements located between an engagement surface of the position controller and first and second angled control engagement surfaces fixed to the handle support for rotation therewith so that rotation of the handle support in one direction rotates the position controller in one direction and rotation of the handle support in the other direction rotates the position controller in the other direction.

9. The pump mechanism according to claim 8, wherein the control rolling elements comprise rollers.

10. The pump mechanism according to claim 8, wherein the clutch assembly further comprises control spring members resiliently biasing the control rolling elements into engagement with the first and second angled control engagement surfaces.

11. The pump mechanism according to claim 10, wherein the control spring members comprise helical coil compression springs.

12. A pump mechanism for a vertical seat lift assembly comprising, in combination:
a control handle pivotable in each direction from a neutral position;
a stationary housing assembly;
a rotatable drive member for operating the vehicle lift assembly;
a clutch assembly operably connecting the drive member to the housing assembly to selectively permit rotation of the drive member relative to the housing assembly in either direction;
wherein the clutch assembly includes at least two rolling elements located between a rubbing surface fixed to the housing and first and second angled engagement surfaces fixed to the drive member for rotation therewith so that rotation of the drive member in one direction is prevented by engagement of one of the rolling elements with the first angled engagement surface and rotation of the drive member in the other direction is prevented by engagement of the other rolling element with the second angled engagement surface;
wherein the clutch assembly further includes a rotatable position controller having tabs adjacent the rolling elements so that rotation of the position controller in one direction disengages the one of the rolling elements engaged with the first angled engagement surface and rotation of the position controller in the other direction disengages the other rolling element from the second angled engagement surface;
control assembly operably connecting the control handle to the clutch assembly to selectively rotate the drive member; and
wherein the control assembly includes a handle support secured to the control handle and at least control two rolling elements located between an engagement surface of the position controller and first and second angled control engagement surfaces fixed to the handle support for rotation therewith so that rotation of the handle support in one direction rotates the position controller in one direction and rotation of the handle support in the other direction rotates the position controller in the other direction.

13. The pump mechanism according to claim 12, wherein the rolling elements comprise rollers.

14. The pump mechanism according to claim 12, wherein the clutch assembly further comprises spring members resiliently biasing the rolling elements into engagement with the first and second angled engagement surfaces.

15. The pump mechanism according to claim 14, wherein the spring members comprise resilient rollers.

16. The pump mechanism according to claim 12, wherein the control assembly is located radially outward of the clutch assembly so that the control assembly does not increase the thickness of the pump mechanism.

17. The pump mechanism according to claim 12, wherein the control rolling elements comprise rollers.

18. The pump mechanism according to claim 12, wherein the clutch assembly further comprises control spring members resiliently biasing the control rolling elements into engagement with the first and second angled control engagement surfaces.

19. The pump mechanism according to claim 18, wherein the control spring members comprise helical coil compression springs.

20. A pump mechanism for a vertical seat lift assembly comprising, in combination:
a control handle pivotable in each direction from a neutral position;
a stationary housing assembly;
a rotatable drive member for operating the vehicle lift assembly;
a clutch assembly operably connecting the drive member to the housing assembly to selectively permit rotation of the drive member relative to the housing assembly in either direction;
wherein the clutch assembly includes at least two rolling elements located between a rubbing surface fixed to the housing and first and second angled engagement surfaces fixed to the drive member for rotation therewith so that rotation of the drive member in one direction is prevented by engagement of one of the rolling elements with the first angled engagement surface and rotation of the drive member in the other direction is prevented by engagement of the other rolling element with the second angled engagement surface;
wherein the clutch assembly further includes a rotatable position controller having tabs adjacent the rolling elements so that rotation of the position controller in one direction disengages the one of the rolling elements engaged with the first angled engagement surface and rotation of the position controller in the other direction disengages the other rolling element from the second angled engagement surface;
wherein the rubbing surface is located radially inward of the first and second angled engagement surfaces;
control assembly operably connecting the control handle to the clutch assembly to selectively rotate the drive member;
wherein the control assembly includes a handle support secured to the control handle and at least control two rolling elements located between an engagement surface of the position controller and first and second angled control engagement surfaces fixed to the handle support for rotation therewith so that rotation of the handle support in one direction rotates the position controller in one direction and rotation of the handle support in the other direction rotates the position controller in the other direction; and
wherein the control assembly is located radially outward of the clutch assembly so that the control assembly does not increase the thickness of the pump mechanism.
